(19) United States
(12) Patent Application Publication
(10) Pub. No.: US 2006/0209083 A1
(43) Pub. Date: Sep. 21, 2006

(54) Method and electroactive device for a dynamic graphical imagery display

(75) Inventor: Louis B. Rosenberg, Arroyo Grande, CA (US)

Correspondence Address: LAW OFFICE OF PHILIP A STEINER, 4251 SOUTH HIGUERA STREET, SUITE 800-Z, SAN LUIS OBISPO, CA, 93401, US

(73) Assignee: Outland Research, L.L.C., Pismo Beach, CA (US)

(21) Appl. No.: 11/341,743

(22) Filed: Jan. 27, 2006

Related U.S. Application Data
(60) Provisional application No. 60/663,500, filed on Mar. 18, 2005.

(51) Int. Cl. G09G 5/00

(52) U.S. Cl. 345/619

(57) ABSTRACT

A low-cost and low-power dynamic graphical imagery display device and method of physically manipulating graphical images in size and/or shape by electronically deforming a compliant surface upon which the graphical images are affixed. The dynamic graphical imagery display device utilizes electroactive polymers and has applications including but not limited to advertising, company logos, printed media, and upon articles of apparel. In one embodiment of the invention, the graphical image is oscillated in size and/or shape under electronic control.

### CROSS-REFERENCE TO RELATED APPLICATIONS

This application is a non-provisional application claiming benefit and priority under 35 U.S.C. § 119(e) from applicant's co-pending U.S. provisional application serial No. 60/663,500 filed on Mar. 18, 2005 to the instant inventor; the aforementioned provisional application is hereby incorporated by reference in its entirety as if fully set forth herein.

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates to electrically controllable graphical images. More specifically, the present invention relates to graphical images affixed to electroactive polymer materials such that they are changed in size and/or shape under electronic control.

### BACKGROUND

Electroactive polymers are electronically controllable materials that convert electrical energy into mechanical displacement. Electroactive polymers are often referred to as “electric muscles” because of their similarity to muscular tissue. In addition, many of the electroactive polymers may be used as high quality sensors, particularly for time-varying (i.e. alternating current) signals. When mechanically deformed (e.g. by bending, pulling, etc.), many electroactive polymers develop differential voltages which can be electrically measured.

A unique property of these materials is their low current requirements in relation to the degree of conformational change exhibited. Electroactive polymers are a class of polymers which may be formulated and/or processed to exhibit a wide range of physical, electrical, and electro-optical behaviors and properties. When energized with a sufficient electromotive force, electroactive polymers undergo significant physical movement or deformations, typically referred to as electrostriction.

Electrostriction is a property of electrical non-conductors (dielectrics) that produces a conformational change, or mechanical deformation, under the application of an electric field. Reversal of the electromotive force does not reverse the direction of the deformation. The selection of the dielectrics used in the production of the electroactive polymers determines the magnitude of the deformation.

The deformations may occur along a length, width, thickness, radius, etc. of the electroactive polymer and in some cases can exceed 100% strain. Elastic strains of this magnitude are uncommon in typical dielectric materials and are even more unusual in that the degree of deformation may be fully controlled with the proper electronic systems. Materials in this class can be used to do useful work in a compact, easy to control, low power, fast, and potentially inexpensive package.

A variety of electroactive polymers structures are described in the technical papers, “High-Field Electrostriction of Elastomeric Polymer Dielectrics for Actuator,” by Kombluh et al., “Electro-Mechanics of lonoelastic Beams as Electrically-Controllable Artificial Muscles,” by M. Shahinpoor, “Polymer Electrolyte Actuator with Gold Electrodes,” by K. Oguro et al., and “Microgripper Design Using Electro-Active Polymers,” by R. Lumia et al. All of the above cited references were obtained from the “SPIE Conference on Electroactive Polymer Actuators and Devices,” SPIE Vol. 3669, 1999, and are hereby incorporated by reference.

Electrostrictive type electroactive polymers are typically constructed from two electrically conductive and compliant electrodes with a dielectric polymer sandwiched between the two electrodes. When significant electromotive forces are exerted on the electrodes, the attractive force of the electrodes constricts the intervening dielectric such that significant motion (strain) is induced. An advantage of the electrostrictive type of electroactive polymers is that deformation may occur uniformly or non-uniformly, across the entire material or at select portions of the material, depending upon the magnitude of electromotive force applied and/or the placement of the electrodes comprising the electroactive graphical imagery display device.

In general, commercial implementations of electroactive polymers have been directed toward development of actuators (e.g., motors) for powering movable robots and mechanical equipment. For example, U.S. Pat. No. 6,376,971, entitled “Electroactive Polymer Electrode,” to Pelrine et al., and issued on Apr. 23, 2002, provide methods for pre-straining electroactive polymers to improve the conversion of electrical energy to mechanical energy. In addition, the patent to Pelrine et al., provides various form factors useful for implementing electrostrictive type electroactive polymers and is herein incorporated by reference in its entirety.

U.S. patent pending application Ser. No. 09/866,385 to Schena, entitled, “Haptic Devices Using Electroactive Polymers,” and filed on May 24, 2001, discloses a wide variety of devices using electroactive polymer actuators. This pending application to Schena is likewise herein incorporated by reference in its entity. However, none of the above cited references provides implementations of electroactive polymers for enabling visually dynamic graphical imagery for applications such as advertising, children's books, apparel, pushbuttons, curios, ornaments or logos which are believed useful and desirous in the relevant art.

### SUMMARY

The invention as described herein addresses the need in the relevant art and provides in various inventive embodiments a graphical imagery display device and method of providing the graphical imagery display device. In a first device embodiment of the invention, a electroactive graphical imagery display device comprises an electroactive polymer device; the electroactive polymer device including a plurality of electrodes and at least one exposed surface. An electromotive force generator is operatively coupled to the plurality of electrodes and a graphical image is affixed to at least one of exposed surface of the graphical imagery display device. The graphical image is affixed to the exposed surface of the electroactive device such that a sufficient voltage applied by the electromotive force generator to the plurality of electrodes causes the graphical image to dynamically change geometric shape in conformity with the deformation of the exposed surface to which it is affixed.

Various embodiments of the invention provides that the graphical image may be affixed using one of; a lamination process, a painting process, a dye sublimation process, a silk screening process, an adhesive process and any combination thereof.

Alternately, or in conjunction therewith, the graphical image may be disposed on a separate elastomeric membrane and the elastomeric membrane is then affixed to the exposed surface of the electroactive polymer device.

In a related embodiment of the invention, the change in geometric shape is an elongation in at least one dimension.

In related embodiments of the invention, the electromotive force generator includes a voltage waveform circuit configured to generate a waveform. The waveform includes at least one of; a sine wave, a square wave, a saw tooth wave, a triangle wave and any combination thereof. A modulator circuit may be operatively coupled to the electromotive force generator to modulate the waveform.

In other related embodiments of the invention, the at least one exposed surface is pre-stressed to allow greater geometric changes in the graphical image; application of the sufficient voltage causes the one exposed surface to become transparent allowing a second graphical image to be visibly perceived; and the electroactive polymer device is configured in a form factor of; a pushbutton, a curio, an ornament, a logo and any combination thereof.

In a second device embodiment of the invention, an electroactive graphical imagery display device comprises an electroactive polymer device. The electroactive polymer device includes a plurality of electrodes, at least one exposed surface and a generally planar form factor. An electromotive force generator is operatively coupled to the plurality of electrodes and a graphical image is affixed to the at least one exposed surface of the graphical imagery display device. The graphical image is affixed to the exposed surface such that a sufficient voltage applied by the electromotive force generator to the plurality of electrodes causes the graphical image to dynamically change geometric shape in conformity with a deformation of the exposed surface to which it is affixed.

In related embodiments of the invention, the sufficient voltage is greater than 100 volts; a modulation circuit is operatively coupled to the electromotive force generator and configured to superimpose a wave form on the sufficient voltage and the electroactive polymer device includes a plurality of independently controllable regions.

In another related embodiment of the invention, separate graphical images are affixed to each of the plurality of independently controllable regions.

In yet another related embodiment of the invention, the electroactive polymer device is coupled to one of; a page of a book, an article of apparel, signage, a curio and any combination thereof.

In a first methodic embodiment of the invention, a method of preparing an electroactive graphical imagery display device is provided. The method comprises providing an electroactive polymer device, providing an electromotive force generator, operatively coupling the electromotive force generator to the electroactive polymer device and affixing a graphical image to at least one exposed surface of the electroactive polymer device.

In related embodiments of the invention, the electroactive polymer device includes a plurality of independently controllable regions where separate graphical images are affixed to each of the plurality of independently controllable regions; the affixing may be accomplished using one of; a lamination process, a painting process, a dye sublimation process, a silk screening process, an adhesive process and any combination thereof.

In another related embodiment of the invention, the electroactive polymer device is configured in a form factor, the form factor being one of; a pushbutton, a curio, an ornament, a logo and any combination thereof.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional components or feature are generally shown in dashed lines. It is intended that changes and modifications can be made to the described embodiment without departing from the true scope and spirit of the subject invention as defined by the claims.

FIG. 1—depicts a perspective view of an embodiment of the invention.

FIG. 1A—depicts a first block diagram of an embodiment of the invention.

FIG. 2A—depicts a second block diagram of another embodiment of the invention.

FIG. 2B—depicts a third block diagram of yet another embodiment of the invention.

FIG. 3A—depicts a constant DC voltage implemented by an embodiment of the invention.

FIG. 3B—depicts a sine wave form superimposed on the constant DC voltage implemented by an embodiment of the invention.

FIG. 3C—depicts a sine wave form implemented by an embodiment of the invention.

FIG. 3D—depicts a square wave form implemented by an embodiment of the invention.

FIG. 3E—depicts a voltage ramp function implemented by an embodiment of the invention.

FIG. 3F—depicts a triangle wave form having a sine wave form superimposed over a triangle wave form implemented by an embodiment of the invention.

FIG. 4A—depicts a de-energized embodiment of the invention implemented on an article of apparel.

FIG. 4B—depicts an energized embodiment of the invention implemented on an article of apparel.

FIG. 4C—depicts an exemplary de-energized embodiment of the invention implemented on an advertising type signage.

FIG. 4D—depicts an exemplary energized embodiment of the invention implemented on advertising signage.

FIG. 5A—depicts an embodiment of the invention where a plurality of independently controllable regions is provided.

FIG. 5B—depicts an embodiment of the invention where a plurality of graphical images are affixed to each independently controllable region.

FIG. 5C—depicts an embodiment of the invention where one of the plurality of graphical images is energized.

FIG. 5D—depicts an embodiment of the invention where two of the plurality of graphical images is energized.

FIG. 6—depicts an embodiment of the invention where an embodiment of the invention includes multiple electrodes.

FIG. 7—depicts a process flow chart of various exemplary embodiments of the invention.

### DETAILED DESCRIPTION

The invention provides in various embodiments a low-cost and low-power dynamic graphical imagery display device and method of physically manipulating graphical images by electronically deforming a compliant surface upon which the graphical images are affixed. The dynamic graphical imagery display device may be used in advertising, company logos, in printed media and on articles of apparel. The use of dynamic graphical imagery is advantageous as it is well known in the relevant art that human visual perception is more sensitive to moving images than those that are static. The appearance of motion unconsciously draws a person's attention to an apparently moving object and away from that of apparent static object. This is the common foundation for slight of hand tricks and magical illusions.

In one embodiment of the invention, the graphical image manipulated under electronic control is a logo that is affixed to product packaging or a product itself.

In another embodiment the graphical image manipulated under electronic control is a logo displayed upon an article of apparel such as a hat, a shirt, or athletic shoes. In another embodiment of the invention, the graphical image manipulated under electronic control is a drawn character such as a cartoon character printed in a book, greeting card, or other printed medium. In another embodiment of the invention, the graphical image manipulated under electronic control is a personified facial depiction such as a drawn or photographed face image.

In another embodiment the graphical image manipulated under electronic control is an advertisement displayed within a magazine, upon posted sign, or upon a posted billboard.

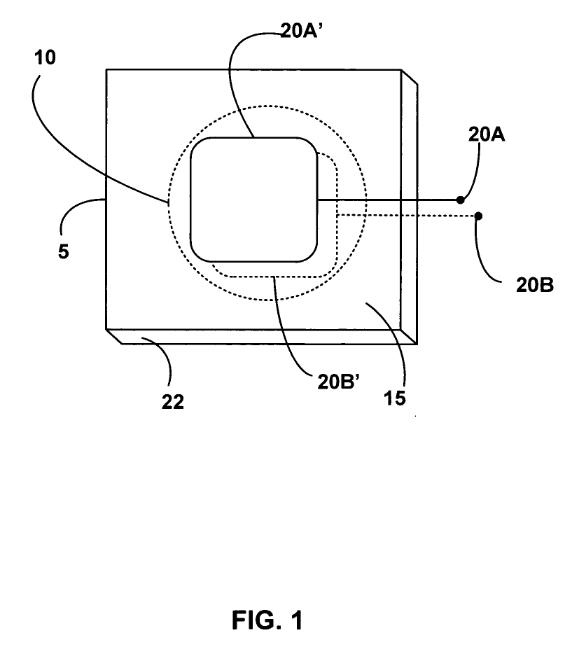

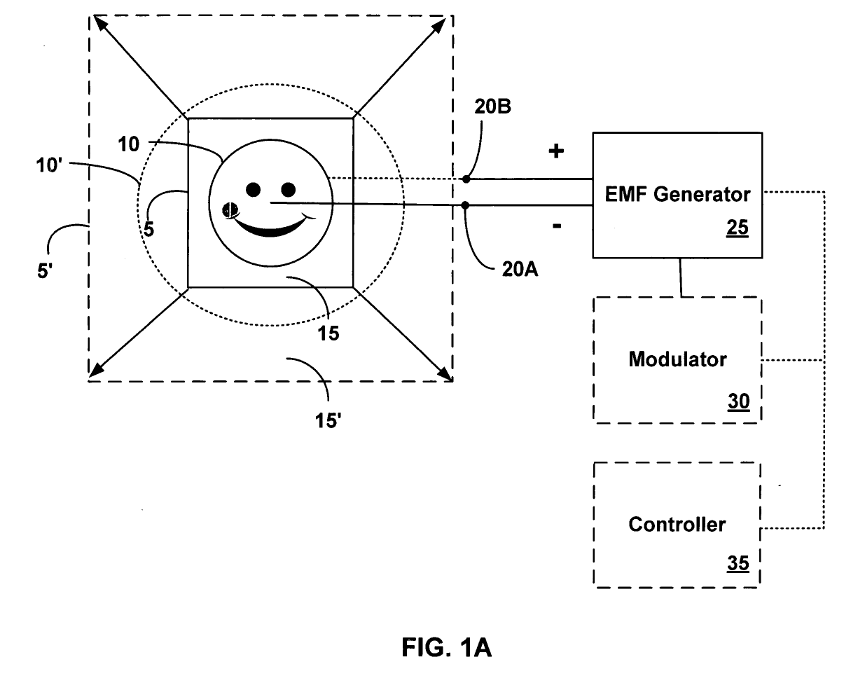

FIG. 1 depicts a perspective view of an embodiment of the invention where a graphical image 10 is affixed to an upper electrode 20A′ of a dynamic graphical imagery display device The graphical image 10 and the lower electrode 20B′ are shown in dotted lines to better illustrate the relative thickness 22 of the electroactive polymeric material 15. Application of a sufficient voltage to the connection leads 20A, 20B coupled to the upper and lower electrodes 20A′, 20B′ causes the electrodes to compress the electroactive polymeric material 15 due to attractive forces, resulting in the deformation of the thickness 22 of the electroactive polymeric material 15 sandwiched between the electrodes 20A′, 20B′. For simplicity and ease of understanding, the electrodes 20A′, 20B′ are referred to hereinafter using their associated leads 20A, 20B. One skilled in the art will appreciate that the electrodes 20A′, 20B′ and connection leads 20A, 20B are closely related but may have different dimensions and be constructed from different conductive materials.

Referring to FIG. 1A, a generalized block diagram of a dynamic graphical imagery display device is depicted. The dynamic graphical display device 5 includes a graphical image 10 affixed to one of its exposed surfaces 15. A graphical image 10 is affixed to the exposed surface of the dynamic graphical display device 5 to at least cover a portion of the region of one of the electrode surfaces. The electrodes 20A, 20B are extremely thin, so that graphical image distortion is not usually a consideration.

However, in situations where the electrode thickness is problematic, a thin layer of compliant material such as latex or similar elastomeric material may be used to provide a gentle transition in surface contours. The electrodes 20A, 20B generate the electrical attractive force when a sufficient electromotive force is received from an electromotive force (EMF) generator 25 coupled thereto.

The EMF generator 25 provides an output voltage that is generally in the range of about 100-500 volts, depending on the specific requirements of the particular electroactive device selected. The graphical image 10 may be applied to an area that only covers at least a portion of the electrode 20A or may cover a portion of the electrode 20A and a portion of the electroactive polymer 15 extending beyond the electrodes 20A, 20B. In either case, the electrodes 20A, 20B should be covered by an insulating material during usage to prevent the possibility of an accidental shock.

The EMF generator 25 may include one or more internal batteries in which the voltage output is increased by a voltage increasing circuit to the 100-500 voltage range. One of the main advantages of electroactive polymer devices is the low current requirements which allows for the use of small electrical power sources (e.g., batteries) to provide the necessary electromotive force.

In general, the EMF generator 25 is a DC to DC converter. In an alternate embodiment of the invention, a DC to AC inverter may be utilized in applications where a varying rate of change is desired in the graphical image 10 affixed to the dynamic graphical display device 5. To be visually perceivable, the AC output frequency should be maintained below 60 Hz. An optional modulator 30 may be coupled to the EMF generator 25 to superimpose AC signals onto a continuously supplied DC voltage.

An optional electronic controller circuit 35 may be provided which varies the modulation, voltage output and/or selects the appropriate electrodes to energize 20A, 20B in accordance with the needs to produce a desired dynamic effect. The electronic controller circuit 35 may be a general purpose computer programmed to provide the desired control or an application specific integrated circuit (ASIC.)

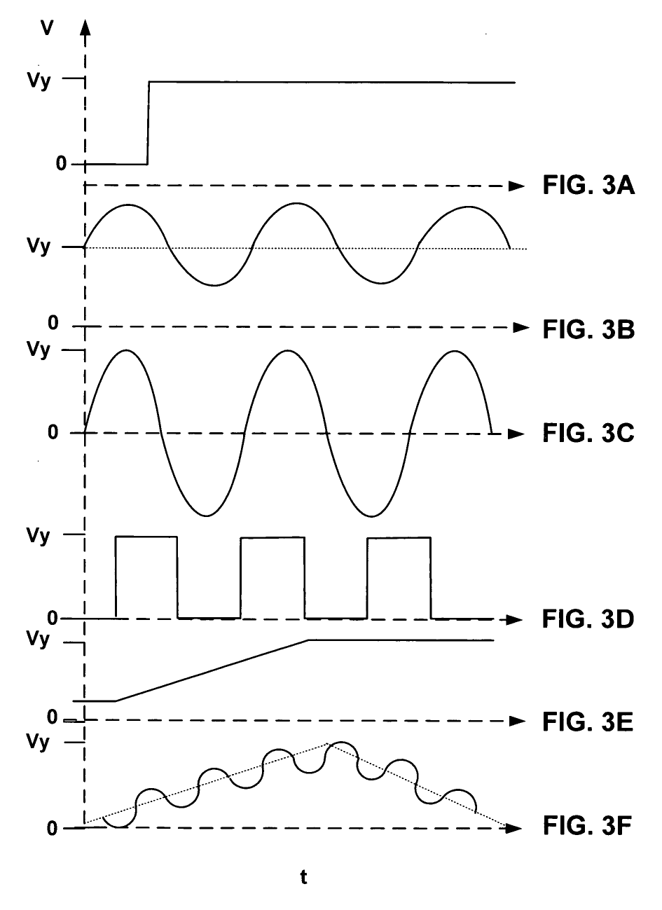

The electronic controller 35 may also be hardwired analog electronics or an embedded microprocessor. If an embedded microprocessor is used, a variety of waveforms (FIGS. 3A-3F for example) can be generated to modulate the voltage applied to the electrodes 20A, 20B.

Application of the output voltage from the EMF generator 25 causes deformation of the polymeric material 15 sandwiched between the electrodes 20A, 20B. In this exemplary embodiment of the invention, application of the output voltage from the EMF generator 25 causes the electroactive polymeric material 15 and the graphical image 10 to deform uniformly to a larger area 5′ and graphical image 10′. Removal of the output voltage allows the electroactive polymeric material 15 and the graphical image 10 to return to their original shapes.

The graphical image 10 may be affixed to the surface of the dynamic graphical imagery display device 5 by several methods. For example, a dry film lamination process may be used to affix a composite structure of photopolymer and polyester film to one of the electrodes 20A, 20B, the electroactive polymeric material 15, and/or the intervening resilient material layer affixed over the electrodes and/or polymer material. Alternately, a thermal dye sublimation process may be used to transfer ink directly onto at least one of the electrodes 20A, 20B and/or electroactive polymeric material 15. Likewise, a simple silk screening process may be used to transfer or paint the graphical image 10 onto one of the electrodes 20A, 20B and/or the electroactive polymeric material 15.

Lastly, an adhesive process may be used where the graphical image 10 is affixed to a thin elastomeric or otherwise compliant material and affixed to one of the electrodes 20A, 20B and/or electroactive polymeric material 15 using an adhesive. Affixing of the graphical image 10 usually is performed when the electroactive polymeric material 15 is expanded (i.e., voltage applied) to allow for higher resolution images.

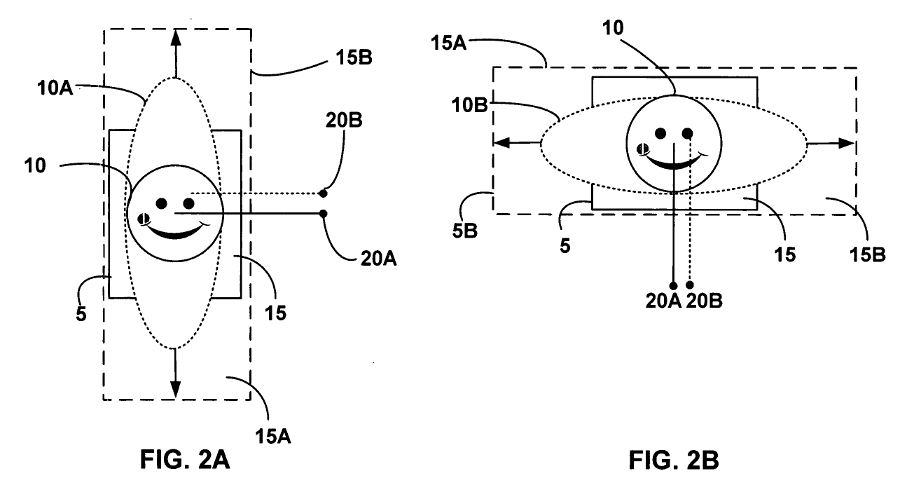

FIGS. 2A and 2B depict selected non-uniform deformations by placing the graphical image 10 over areas of the electroactive polymeric material 15 having different amounts of pre-strain. Pre-strain can be used to provide graphical images 10A, 10B having differences in horizontal and vertical stretch, thus providing desirable non-uniform image deformations.

In non-uniform deformation, a given area of electroactive polymer material 15 may be prepared such that the amount of stretch achieved for a given voltage change is not identical in the vertical dimension as shown in FIG. 2A. The graphical image 10 and electroactive polymeric material 15 expands considerably more in the vertical dimension 15A than in the horizontal dimension 15B due to the pre-stress. Analogously, as shown in FIG. 2B, pre-stressing the electroactive polymeric material 15 in the horizontal dimension allows considerably greater expansion in the horizontal dimension 15B than in the vertical dimension 15A. The affixed graphical image 10 likewise 10A, 10B expands in conformance with the underlying electroactive polymeric material 15 to which the image is affixed. Pre-stress is accomplished during the manufacturing process by pre-stretching the material more in the horizontal dimension 15A than in the vertical direction 15B (or vice versa).

By having significantly different amounts of pre-stretch, the amount of deformation can be substantially different in these two directions when a voltage is applied. For example, an area of electroactive polymer material 15 could be prepared such that when a voltage of about 500V is applied, the stretch in the horizontal axis is 400% while the stretch in the vertical axis is only 50% based on the specific values selected during the manufacturing process.

FIGS. 3A-3F depict exemplary wave forms which may be generated by the EMF generator 25. The Y axis indicates the amount of electromotive force in volts Vy being applied to the dynamic graphical display device 5. The X axis is time t.

Each of the varying wave forms will have a different effect on the dynamic graphical display device 5 and the graphical image 15 affixed thereto. The wave forms depicted are only intended as examples of common wave forms. Other wave forms such as increasing and decreasing voltage ramps, complex modulations and other wave forms are envisioned as well.

FIG. 3A depicts a constant DC voltage being applied to the electrodes 20A, 20B of the dynamic graphical display device 5. A constant DC voltage causes the electroactive polymer material 15 to remain in a deformed (compressed and elongated) steady state until the voltage is removed.

FIG. 3B depicts a sinusoidally varying wave form superimposed over a constant DC voltage being applied to the electrodes 20A, 20B of the dynamic graphical display device 5. The addition of a varying wave form causes the electroactive polymer material 15 to partially deform in response to the applied DC voltage and dynamically vary the deformations in concert with the frequency of the superimposed sinusoidal wave form.

FIG. 3C depicts a sinusoidal wave form (AC signal source) being applied to the electrodes 20A, 20B of the dynamic graphical display device 5. The application of a varying wave form causes the electroactive polymer material 15 to deform in concert with the frequency of the sinusoidal wave form.

FIG. 3D depicts a square wave form (pulse signal source) being applied to the electrodes 20A, 20B of the dynamic graphical display device 5. The application of a square wave form causes the electroactive polymer material 15 to deform in concert with the pulse width (time variable) and height (voltage variable) of the square wave form.

FIG. 3E depicts an increasing DC voltage ramp function being applied to the electrodes 20A, 20B of the dynamic graphical display device 5. The application of an increasing DC voltage ramp function causes the electroactive polymer material 15 to deform in concert with the increasing voltage applied until a maximum applied voltage has been applied. Once the maximum applied voltage has been applied, the deformation of the electroactive polymer material 15 maintains a steady state.

FIG. 3F depicts a triangle DC voltage wave form superimposed with a sinusoidal wave form being applied to the electrodes 20A, 20B of the dynamic graphical display device 5. The application of a triangle DC wave form causes the electroactive polymer material 15 to deform in concert with the increasing and decreasing voltage applied to the electrodes 20A, 20B.

In addition, the superimposed sinusoidal wave form causes the deformation of the electroactive polymer material 15 to further vary as a time and voltage function in concert with the applied sine wave, thus rendering a “shimmering” effect to the electroactive polymer material 15 and any graphical image 10 affixed thereto. The various wave forms described above may be used to make a graphical image 10 appear to expand slowly, as if growing over time form the small size to the large size. To achieve the slow change in visual perspective, the electronic controller 35 may be programmed to slowly vary the voltage from an initial value (0 V) to a final value (500 V).

The voltage may be varied linearly or non-linearly, depending upon the desired change in visual perception. Additionally, the voltage may be varied across a dynamic function, such a slowly growing DC voltage with a small oscillating AC signal superimposed upon a based DC voltage. This overlaid oscillating signal could be used to make the graphical image 10 appear “alive” simulating an image of a cartoon.

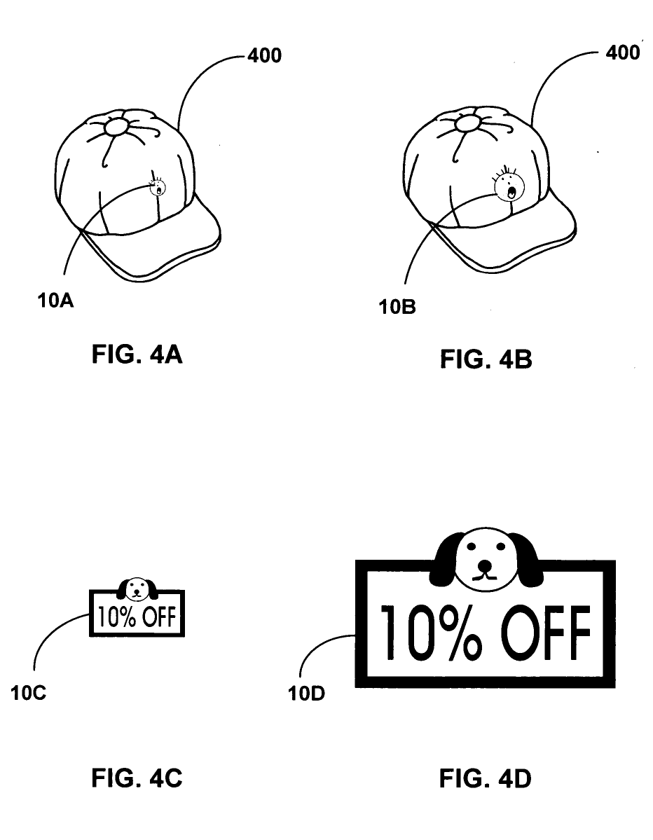

Referring to FIGS. 4A and 4B, an exemplary implementation of the invention is depicted. In this example, a graphical image 10A is affixed to a baseball cap 400 as patch or team logo. The fabric material under or surrounding the patch could be constructed from a flexible cloth or elastomeric material to allow for the deformation of the graphical image 10A. The electronic controller 35 and EMF generator 25 may be hidden in the back of the cap 400 or sewn into the cap's lining. The graphical image 10A is affixed to a dynamic graphical display device 5 as previously described. In this example, an electronic controller 35 is configured to periodically expand the graphical image 10B and contract the graphical image 10A. In various embodiments of the invention, such as print media images, company logos or graphics on packaging, it may be useful to include a touch sensor coupled to the local control electronics (usually via a local processor) such that when the image itself is touched the image deformations are triggered. For example, a logo on the cap 400 shown in FIGS. 4A and 4B include a graphical image 10A, 10B that performs its deformation routine when the wearer lightly touches the graphical image 10A, 10B with his or her finger.

Because electroactive polymer actuators may act as sensors as well as actuators the same electro-active polymer structure can be used as both the sensor for touching the image as well as the actuator for deforming the image. The sensor works by detecting a voltage and/or current produced or changed as a result of a person pressing upon the compliant material and compressing the electrodes together by a sufficient amount.

FIGS. 4C and 4B depict another exemplary embodiment of the invention where a dynamic graphical display device 5 is included on packaging or provided as advertising. As previously discussed, human visual perception is far more sensitive to apparent movement than to constant images. Therefore, a dynamic graphical display device S added to traditional packaging, product labeling and advertising may be used as a means of attracting the attention of a prospective customer to a particular product or service.

For example, product slogans, product names, product logos, and other similar advertising information could be made to expand, contract, oscillate, and otherwise change over time as dynamic graphical images 10C. In this example, a graphical image 10C may be affixed to product packaging via a dynamic graphical display device 5 and may be controlled by embedded electronics to slowly oscillate between two states 10C, 10D, rapidly oscillate between two states 10C, 10D, or otherwise deform based upon a time varying voltage signal provided by a controller 35.

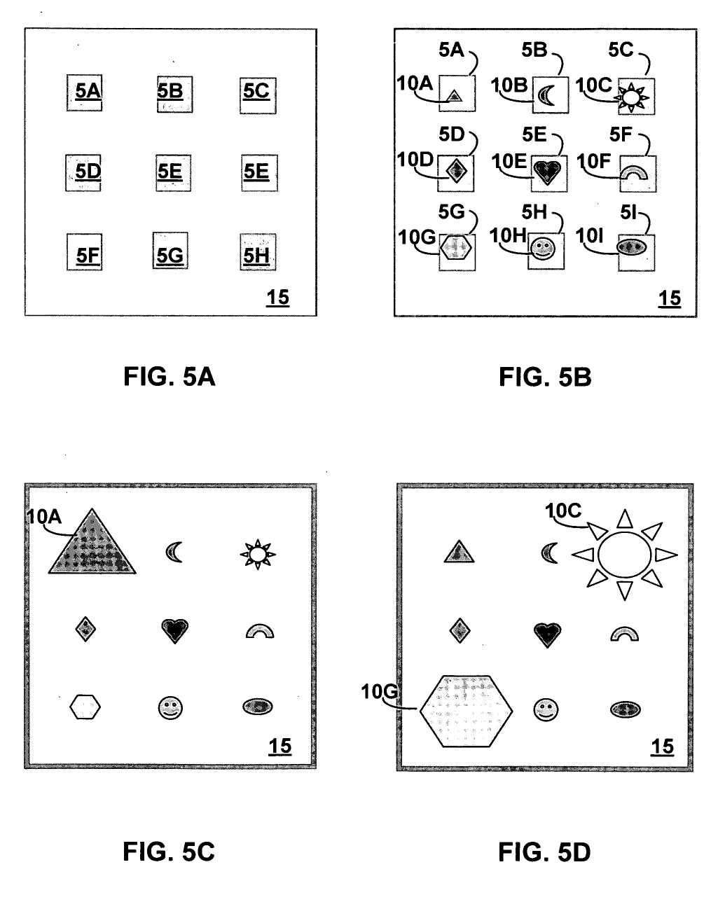

FIGS. 5A and 5B provides an exemplary embodiment of the invention where multiple graphical images 10A-10I may be affixed to an electroactive polymer material 15 having nine independently controllable electrode regions 5A-5H.

In this embodiment of the invention, a single sheet of electroactive polymer material 15 includes multiple electrodes (not shown) under independent or coordinated control by the electronic controller 35. Using such a configuration, multiple graphical images 10A-10I can be transferred to the electroactive polymer material 15, each of which being selectively energized by the electronic controller 35 as is depicted in FIGS. 5C and 5D.

In FIG. 5C, one graphical image 10A is selected out of all of the graphical images 10A-10I and energized to cause an increase in its size. In FIG. 5D, two graphical images 10C and 10G are selected out of all the graphical images 10A-10I and energized to cause an increase in their size. This multiple graphical image 10A-10I embodiment of the invention provides for example, diverse image control on a single page of text within a printed media. In another example, a different color, shape, number, or letter could be graphically imaged above each independently controllable electrode regions 5A-5H. A reader of the printed media could therefore see different graphical images 10A-10I by interacting or observing variations in the shapes, numbers, colors, or letters, which have been expanded while reading the printed media.

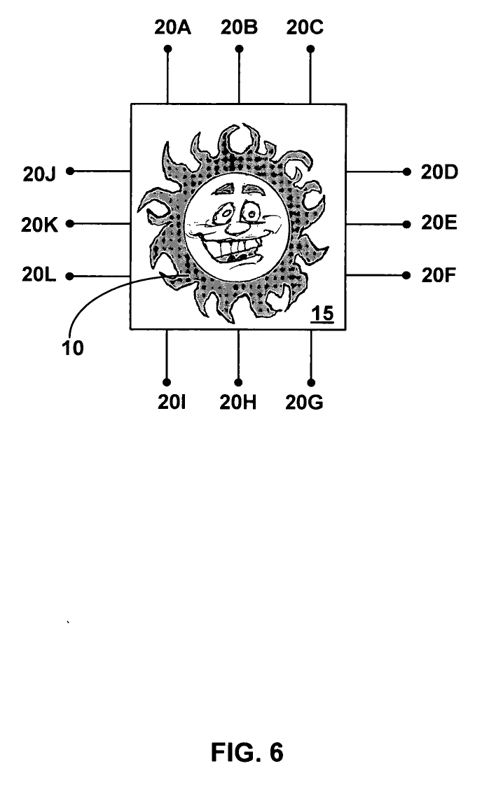

Referring to FIG. 6, another exemplary embodiment of the invention is depicted where a graphical image 10A is affixed to an electroactive polymer device 15 that is provided with multiple electrodes 20A-20L which may be separately and selectively energized by a controller 35. By separately and selectively energizing one or more of the electrodes 20A-20J, the graphical image 10A may be transformed into various geometries. The layout of the electrodes 20A-20J does not need to be uniform. For example, a graphical image 10 of a body or a face could have electrodes of various shapes and sizes positioned such that they fall under various body parts that can be independently activated. For instance, the example of graphical image 10A, each eye may be controlled in size and/or shape independently by different pairs of electrodes placed under each eye region. Similarly the mouth may be controlled in size and/or shape independently by a dedicated pair of electrodes placed under the mouth region.

In another example, a cartoon face is printed upon an electroactive polymer material 15, in which the individual electrodes of varying size and shape are positioned under the graphical image 10 such that electrodes are present under each eye, each ear, the nose, the mouth, and under the hair. In such embodiments, the electronic controller 35 can selectively energize these electrodes 20A-20J to render motion to the features of the cartoon face, allowing for electronic control of facial features and expressions.

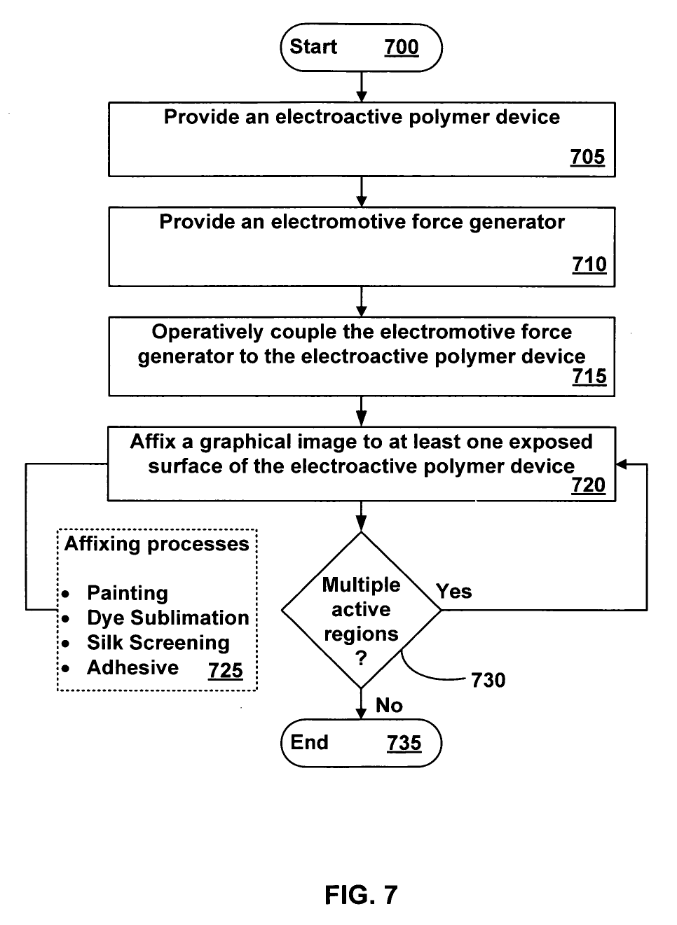

Referring to FIG. 7, a process flow chart for preparing a dynamic electroactive graphical imagery display device is depicted. The process is initiated 700 by providing an electroactive polymer device 705 and an electromotive force generator 710

The electromotive force generator is operatively coupled to the electroactive polymer device 715. A graphical image is affixed to at least one exposed surface of the electroactive polymer device 720. If the there are multiple active regions 730 on the electroactive polymer device, the process 720 is repeated until all desired active regions have a graphical image affixed thereto 730. Alternately or in conjunction therewith, the process ends 735 upon completion of the affixing portion of the process 720. The affixing process may 725 be accomplished using one or more processes such as painting, dye sublimation, silk screening, and adhesive bonding.

The foregoing described embodiments of the invention are provided as illustrations and descriptions. They are not intended to limit the invention to the precise form described or an order presented. In particular, it is contemplated that certain functional implementations of the invention described herein may be constructed from various types of electroactive polymers. Electronic control over the graphical imagery display device may be implemented equivalently in hardware, software, firmware, and/or other available functional components or building blocks and materials. Other variations and embodiments are possible in light of above teachings, and it is not intended that this Detailed Description limit the scope of invention, but rather by the Claims following herein.

What is claimed:

1. A dynamic graphical imagery display device comprising:
an electroactive polymer device including;
a plurality of electrodes; and,
at least one exposed surface;
an electromotive force generator operatively coupled to said plurality of electrodes;
a graphical image affixed to said at least one exposed surface; and,
wherein said graphical image is affixed to said at least one exposed surface such that a sufficient voltage applied by said electromotive force generator to said plurality of electrodes causes said graphical image to dynamically change geometric shape in conformity with a deformation of said at least one exposed surface.

2. The display device according to claim 1 wherein said change in geometric shape comprises an elongation in at least one dimension.

3. The display device according to claim 1 wherein said electromotive force generator includes a voltage waveform circuit configured to generate a waveform, said waveform including one of a sine wave, a square wave, a saw tooth wave, a triangle wave and any combination thereof.

4. The display device according to claim 1 wherein said graphical image is affixed using one of; a lamination process, a painting process, a dye sublimation process, a silk screening process, an adhesive process and any combination thereof.

5. The display device according to claim 4 wherein said graphical image is disposed on a separate elastomeric membrane and wherein said elastomeric membrane is affixed to said at least one exposed surface.

6. The display device according to claim 1 wherein at least a portion of said at least one exposed surface is pre-stressed in at least one dimension to allow a greater geometric change in said graphical image.

7. The display device according to claim 1 wherein said electroactive polymer device is configured in a form factor, said form factor being one of; a pushbutton, a curio, an ornament, a logo and any combination thereof.

8. The display device according to claim 1 wherein said change is an oscillatory change in geometric shape in conformance with a frequency of said waveform.

9. The display device according to claim 1 wherein said graphical image comprises a depiction of a personified face where at least a portion of said personified face deforms under electronic control.

10. The display device according to claim 1 wherein said graphical image comprises a depiction of a cartoon character where at least a portion of said cartoon character deforms under electronic control.

11. A dynamic graphical imagery display device comprising:
an electroactive polymer device including;
a plurality of electrodes;
at least one exposed surface; and,
a generally planar form factor;
an electromotive force generator operatively coupled to said plurality of electrodes;
a graphical image affixed to said at least one exposed surface; and,
wherein said graphical image is affixed to said at least one exposed surface such that a sufficient voltage applied by said electromotive force generator to said plurality of electrodes causes said graphical image to dynamically change geometric shape in conformity with a deformation of said at least one exposed surface.

12. The display device according to claim 11 wherein said sufficient voltage is greater than 100 volts.

13. The display device according to claim 11 wherein a modulation circuit is operatively coupled to said electromotive force generator and configured to superimpose a wave form on said sufficient voltage.

14. The display device according to claim 11 wherein said electroactive polymer device includes a plurality of independently controllable regions.

15. The display device according to claim 14 wherein separate graphical images are affixed to each of said plurality of independently controllable regions.

16. The display device according to claim 11 wherein said electroactive polymer device is coupled to an article of apparel.

17. The display device according to claim 11 wherein said electroactive graphical display devices comprises a logo affixed to a product that is geometrically changed in at least one dimension under electronic control.

18. A method of preparing a dynamic graphical imagery display device comprising:
providing an electroactive polymer device;
providing an electromotive force generator;
operatively coupling said electromotive force generator to said electroactive polymer device; and,
affixing a graphical image to at least one exposed surface of said electroactive polymer device.

19. The method according to claim 18 wherein said electroactive polymer device includes a plurality of independently controllable regions.

20. The method according to claim 18 further including, affixing separate graphical images to each of said plurality of independently controllable regions.

21. The method according to claim 18 wherein said affixing is accomplished using at least one of; a lamination process, a painting process, a dye sublimation process, a silk screening process, an adhesive process and any combination thereof.

22. The method according to claim 18 wherein said electroactive polymer device is configured in a form factor, said form factor being one of; a pushbutton, a curio, an ornament, a logo and any combination thereof.

23. The method according to claim 18 wherein said graphical image is geometrically changed in at least one dimension under electronic control.
